(19) United States
(12) Patent Application Publication
(10) Pub. No.: US 2008/0165271 A1
(43) Pub. Date: Jul. 10, 2008

(54) Image pickup apparatus

(75) Inventors: Koichi Nakazawa, Tokyo (JP); Hiroshi Hasegawa, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Opto, Inc., Tokyo (JP)

(21) Appl. No.: 12/006,545

(22) Filed: Jan. 3, 2008

(30) Foreign Application Priority Data
Jan. 10, 2007 (JP) JP2007-002249

(51) Int. Cl. H04N 5/225

(52) U.S. Cl. 348/340; 348/E05.024

(57) ABSTRACT

An image pickup apparatus relating to the present invention includes an image pickup optical system with variable power for forming an image of an subject; an image pickup element for photo-electrically converting the image; and a drive member for moving the image pickup element or at least a part of the image pickup optical system in a direction different from an optical axis of the image pickup optical system. The drive member moves the image pickup element or at least a part of the image pickup optical system when power of the image pickup optical system is varied, to correct a movement of the image due to varying the power. Alternatively, the drive member is driven by an operation of an external member of the image pickup apparatus to shift a shooting area of the image.

This application is based on Japanese Patent Application No. 2007-002249 filed on Jan. 10, 2007, in Japanese Patent Office, the entire content of which is hereby incorporated by reference.

### TECHNICAL FIELD

The present invention relates to an image pickup apparatus that is equipped with a mechanism which moves at least a part of an image pickup optical system or an image pickup element in the direction that is different from an optical axis of the image pickup optical system.

### BACKGROUND

Camera shake correcting technologies to obtain a clear image by correcting shift of an image caused by camera shake have so far been put into practical use. Among these camera shake correcting technologies, there are known three types of technologies as an optical correcting method: a type to move a part of an image pickup optical system; a type to move the whole of the image pickup optical system; and a type to move an image pickup element.

The Japanese Patent Publication Open to Public Inspection (JP-A) No. 2000-13671 discloses a technique for correcting camera shake by a drive mechanism that is composed to move a part of lenses in an image pickup optical system having a variable focal length in two directions each being perpendicular to an optical axis, among the aforesaid three types of camera shake correcting technologies in an optical correcting method.

Further, JP-A No. 2003-110929 discloses an image pickup apparatus wherein camera shake is corrected by a drive mechanism that is composed to move an image pickup element in two directions each being perpendicular to an optical axis.

However, the drive mechanism described in each of the aforesaid JP-A No. 2000-13671 and JP-A No. 2003-110929 is used only for correction of camera shake. This drive mechanism is composed of the first drive mechanism that moves a frame holding a lens or an image pickup element in the prescribed direction and the second drive mechanism that supports the frame and the first drive mechanism, and moves them in the direction perpendicular to the direction in which the frame is moved by the first movement mechanism.

Namely, the drive mechanism stated above is complicated in terms of a mechanism to be high in cost, and it causes an image pickup apparatus to be rather high in cost if it is used only for correction of camera shake.

### SUMMARY

Incidentally, in an image pickup apparatus having an image pickup optical system with variable power, if a lens barrel that houses therein the image pickup optical system has minute errors of parts and manufacturing errors, a lens group that constitutes the image pickup optical system sometimes deviates from the optical axis when the lens group moves for varying power due to the minute errors of parts and manufacturing errors. When an image is shot with a certain focal distance with such a structure, the center point of the image field is undesirably displaced after the power is varied, resulting in a problem that an image of a subject is moved on an imaging plane. Preventing the image from the movement is an object of the present invention.

Further, when the image pickup apparatus is fixed on a tripod to be used, there is a demand to fine-tune an image-shooting area, so that an image of a subject may be positioned at a desired location, without loosening a cramp of the tripod. This is another object.

The invention is provided to obtain an image pickup apparatus in view of these objects by using a drive member that moves at least a part of the image pickup optical system or an image pickup element in the direction different from the optical axis direction.

An embodiment of the present invention of is an image pickup apparatus comprising an image pickup optical system with variable power for forming an image of an subject; an image pickup element for photo-electrically converting the image formed by the image pickup optical system; and a drive member for moving the image pickup element in a plane perpendicular to an optical axis of the image pickup optical system. When power of the image pickup optical system is varied, the drive member moves the image pickup element in the plane perpendicular to the optical axis of the image pickup optical system, to correct a movement of the image due to varying the power.

Another embodiment of the present invention is an image pickup apparatus comprising: an image pickup optical system with variable power for forming an image of an subject; an image pickup element for photo-electrically converting the image formed by the image pickup optical system; and a drive member for moving at least a part of the image pickup optical system in a direction different from an optical axis of the image pickup optical system. When power of the image pickup optical system is varied, the drive member moves the at least the part of the image pickup optical system in the direction different from the optical axis of the image pickup optical system, to correct a movement of the image due to varying the power.

In the above embodiments, the drive member may correct an image shake due to a shake of the image pickup apparatus when the image pickup apparatus shoots the image.

In the above embodiment, the image pickup apparatus may further comprise a recording medium storing information about an amount and direction of a movement of the image pickup element or the at least the part of the image pickup optical system. When the power of the image pickup optical system is varied, the drive member may move the image pickup element or the at least the part of the image pickup optical system in the direction different from the optical axis of the image pickup optical system based on the information stored in the recording medium.

Another embodiment of the present invention is an image pickup apparatus comprising: an image pickup optical system with variable power for forming an image of an subject; an image pickup element for photo-electrically converting the image formed by the image pickup optical system; a drive member for moving the image pickup element in a plane perpendicular to an optical axis of the image pickup optical system; and an external operation member for driving the drive member by an operation thereof to shift a shooting area of the image.

Another embodiment of the present invention is an image pickup apparatus comprising: an image pickup optical system with variable power for forming an image of an subject; an image pickup element for photo-electrically converting the image formed by the image pickup optical system; a drive member for moving at least a part of the image pickup optical system in a direction different from an optical axis of the image pickup optical system, and an external operation member for driving the drive member by an operation thereof to shift a shooting area of the image.

In the above embodiments, the drive member may correct an image shake due to a shake of the image pickup apparatus when the image pickup apparatus shoots the image.

In the above embodiments, the image pickup apparatus may further comprises: a judging section for judging whether a tripod is attached to the image pickup apparatus or not. When the judging section judges that the tripod is not attached to the image pickup apparatus, the external operation member does not drive the drive member.

In the image pickup apparatus relating to the invention, a drive member that moves at least a part of the image pickup optical system or an image pickup element in the direction different from the optical axis direction makes it possible to correct image movement in the case of varying power of the image pickup optical system and to fine-tune an image-shooting area by the image pickup apparatus, thus, it is possible to obtain an image pickup apparatus wherein new functions are added without additional cost.

These and other objects, features and advantages according to the present invention will become more apparent upon reading of the following detailed description along with the accompanied drawings.

### BRIEF DESCRIPTION OF THE DRAWINGS

Embodiments will now be described, by way of example only, with reference to the accompanying drawings which are meant to be exemplary, not limiting, and wherein like elements numbered alike in several Figures, in which:

FIG. 1 is a diagram showing an example of an internal arrangement of a primary construction unit of a camera representing an example of an image pickup apparatus relating to the First Embodiment;

FIG. 2 is a block diagram showing a brief overview of a camera relating to the First Embodiment;

FIG. 3 is a sectional view of a lens barrel relating to the First Embodiment;

FIG. 4 is a schematic diagram showing an outline of a drive member for varying power in a lens barrel relating to the First Embodiment;

Each of FIGS. 5(a) and 5(b) is a schematic diagram showing operations for preventing image from moving due to varying power;

FIG. 6 is a flow chart showing an outline of operations in a shooting mode of a camera relating to the First Embodiment;

FIG. 7 is a block diagram showing a brief overview of a camera relating to the Second Embodiment;

Each of FIGS. 8(a) and 8(b) is a schematic diagram showing operations for preventing image from moving due to varying power;

FIG. 9 is a flow chart showing an outline of operations in a shooting mode of a camera relating to the Second Embodiment;

FIG. 10 is a block diagram showing a brief overview of a camera relating to the Third Embodiment;

FIG. 11 is a sectional view showing an outline of a switch at a tripod mount section; and

FIG. 12 is a flow chart showing an outline of operations in a shooting mode of a camera relating to the Third Embodiment.

### DESCRIPTION OF THE PREFERRED EMBODIMENT

The invention will be explained in detail as follows, referring to the embodiment to which, however, the invention is not limited.

### First Embodiment

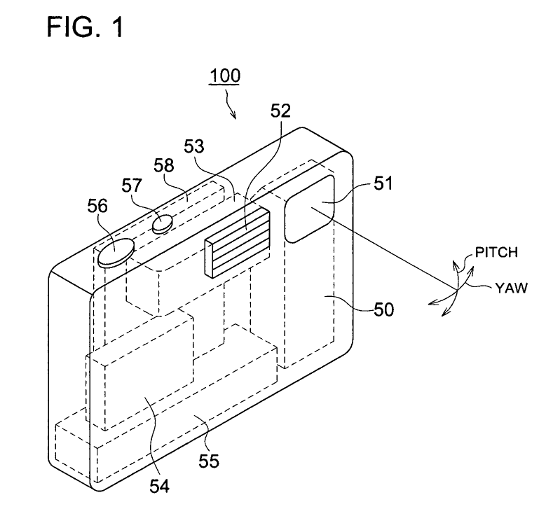

FIG. 1 is a drawing showing an example of the internal arrangement of the major constitution unit of a camera 100 which is an example of the image pickup apparatus including the lens unit relating to this embodiment. FIG. 1 is a perspective view of the camera 100 viewed from the subject side.

As shown in FIG. 1, camera 100 is provided with lens frame 50 containing a folded image pickup optical system with variable power vertically arranged on the right portion of the camera and with opening 51 formed so as to take in the light flux from the object. On the opening 51, there is installed a lens barrier for switching the open status for exposing the opening 51 and the closed status for covering the opening 51.

The camera 100 is further provided with a flash emission window 52. Behind the flash emission window 52, there is arranged a flash unit 53 including a light reflector, a xenon tube, a main capacitor, and a circuit base board. In FIG. 1, there are provided an image recording memory 54 of a card type and a battery 85 which supplies power to each unit of the camera. The image recording memory 54 and battery 55 can be mounted or demounted through a cover.

There is arranged release button 56 on the top of the camera 100. When the button is pressed to the first stage (may be referred also to as ON of Switch S1), the imaging preparation operation of the camera, that is, the focusing operation and beam measuring operation are performed, and when the button is pressed to the second stage (may be referred also to as ON of Switch S2), the imaging exposure operation is performed. The camera 100 is also provided with a main switch 57 which changes the operation status of the camera and the non-operation status thereof. When the camera is switched to the operation status by the main switch 57, the lens barrier is put into the open status and each unit starts operation. Further, when the camera is switched to the non-operation status by the main switch 57, the lens barrier is put into the closed status and each unit finishes the operation.

On the rear of the camera, there is arranged a display unit 58 composed of an element such as LCD and an organic EL for displaying an image and character information. There are further arranged operation members on the rear of the camera, such as a zoom button for performing zoom up and zoom down, a reproduction button for reproducing a picked-up image, a menu button for displaying various menus on the display unit 88, and a selection button for selecting a desired function from the display.

Further, between the above major constitution units, there is arranged a circuit board. The circuit board has various loaded electronic parts for connecting the major constitution units, and drives and controls the major constitution units. The camera is further provided with an external I/O terminal, a strap mounting unit, and a tripod seat.

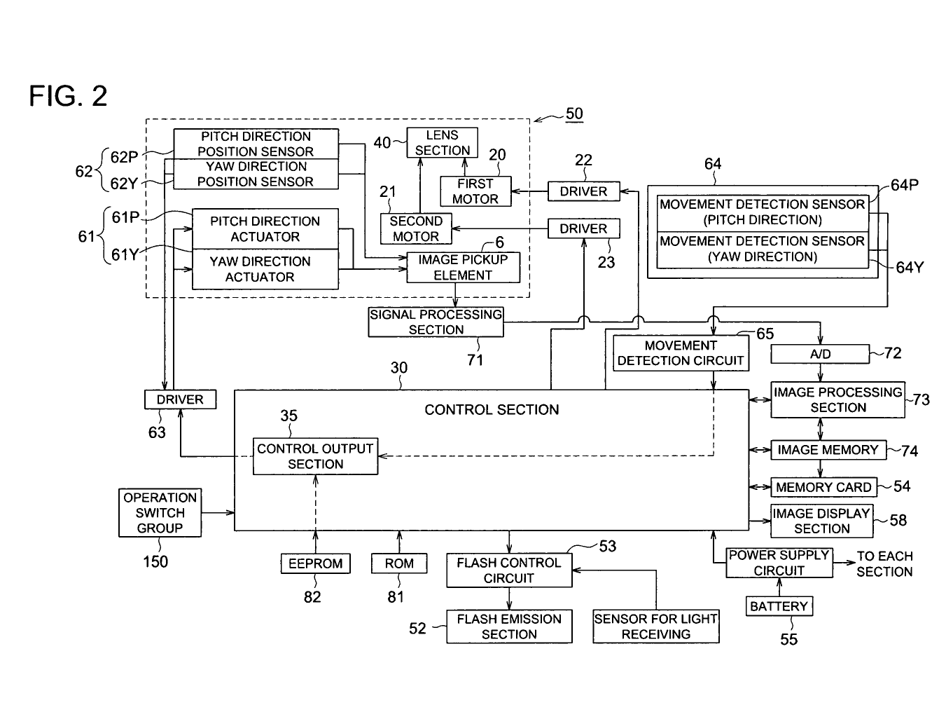

FIG. 2 is a block diagram showing a brief overview of camera 100 relating to the First Embodiment.

As shown in FIG. 2, in lens section 40 in lens barrel 50, a prescribed lens group is moved by the first motor 20 and second motor 21, so that power is varied and a focal point is adjusted. Further, in lens barrel 50, there is provided actuator 61 that moves image pickup element 6 in the direction to cancel image movement in the yaw direction and pitch direction shown in FIG. 1. A movement of image pickup element 6 in the pitch direction is conducted by pitch direction actuator 61P, and a movement in the yaw direction is conducted by yaw direction actuator 61Y. There is further provided sensor 62 that detects a movement position of image pickup element 6 by actuator 61, and a position in the pitch direction is detected by pitch direction position sensor 62P and a position in the yaw direction is detected by yaw direction position sensor 62Y.

The actuator 61 is driven by driver 63 controlled by control section 30, and the first motor 20 and the second motor 21 are also driven respectively by driver 22 and driver 23.

Movement detection sensor 64 detects a movement of camera 100. Specifically, movement detection sensor 64P detects the angular velocity in the pitch direction, which is in detail, inertial angular velocity (ground angular velocity), and movement detection sensor 64Y detects the angular velocity in the yaw direction.

Signals coming from movement detection sensors 64P and 64Y are amplified by movement detection circuit 65 and filtering processing is applied to them. The signals are detected as signals showing “movement” to be inputted in control section 30 constituted with, for example, a microcomputer.

In the control section 30, the prescribed software program stored in ROM 81 is executed, and functions of respective sections operate. For example, control output section 35 obtains a current angle in each of a pitch direction and a yaw direction based on signals from the movement detection circuit 65, and obtains an output value of a servo-control system that makes a difference between the current angle and a target angle to be small. Namely, there is generated a control instruction value for driving image pickup element 6 for in-plane displacement to control the movement detected by the movement detection circuit 65. The control output section 35 outputs the generated control instruction values to driver 63.

The driver 63 drives pitch direction actuator 61P and yaw direction actuator 61Y, based on the control instruction values. It causes in-plane displacement of the image pickup element 6, and image shake due to the camera shake is corrected. Each of pitch direction position sensor 62P and yaw direction position sensor 62Y is a sensor that detects a position of the image pickup element 6 that is driven by actuator 61 for in-plane displacement, and controls driving of image pickup element 6 for displacement on a feed back basis.

Further, in camera 100 of the First Embodiment, the drive member for in-plane displacement of the aforesaid image pickup element 6 is provided for causing in-plane displacement of the image pickup element 6 not only when the image shake due to the camera shake is corrected but also when the first motor 20 and the second motor 20 are driven, namely, the lens group in the lens section 40 is moved for varying power.

The control of in-plane displacement of image pickup element 6 when the lens group for varying power is moved is made as follows.

A recording medium EEPROM 82 stores a look-up table (LUT) in advance, and positions to which the image pickup element 6 should be displaced are recorded on LUT with corresponding to positions of the lens group. This LUT is written to the EEPROM 82 in the course of manufacturing before shipment.

Control section 30 reads out LUT from EEPROM 82 when driving first motor 20 and second motor 21 through drivers 22 and 23 for varying power. Control output section 35 is arranged so that it can drive actuator 61 based on the LUT and can cause the image pickup element 6 to perform in-plane displacement. Owing to this, image is prevented from movement caused by a deviation (a shift or a tilt) of a lens group from an optical axis resulted from minute part errors or manufacturing errors of lens barrel 50.

“An image movement” mentioned in the present example means that a center point of the image field that is imaged at a certain focal distance is displaced due to a shift or a tilt of a lens moved for varying power, and falls out of the original center point of the image field. Further, “preventing image from movement” means that an image movement is controlled when varying power to the level where it is difficult to confirm image movement visually.

In addition, on the camera 100, there are provided signal processing section 71 serving as a processing section that handles images obtained by image pickup element 6, A/D converting section 72, image processing section 73 and image memory 74. An image of analog signals obtained by image pickup element 6 is A/D-converted by A/D converting section 72 through signal processing section 71, then, prescribed image processing is applied to it with image processing section 73, and the processed image is stored temporarily in image memory 74. The image stored in the image memory 74 is recorded on memory card 54, or are processed by desired processing and is displayed on an image display section 58 as a live-view display image.

Further, to the control section 30, there are connected groups of operation switch 150 such as a cross-key button, a zoom-operation button, a mode-selection dial and a mode-setting button, and the camera 100 is operated by operations of a user based on that operations.

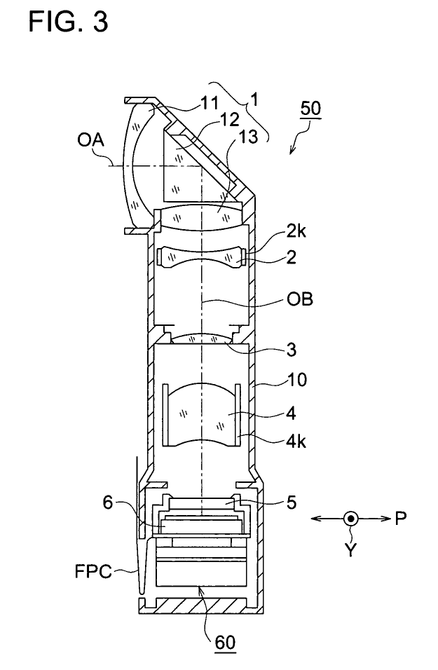

FIG. 3 is a cross sectional view showing the folded image-pickup optical system with variable power built in the lens barrel 50 relating to First Embodiment. FIG. 3 shows a cross sectional view sectioned by a plane including the optical axis before being bent and the optical axis after being bent.

As shown in FIG. 3, OA indicates the optical axis before being bent and OB indicates the optical axis after being bent. The optical system is provided with a first lens group 1. The first lens group 1 is composed of a lens 11 having the optical axis OA and arranged with facing a subject, a prism 12 which is a reflection member for bending the optical axis OA almost at right angles, and a lens 13 arranged so as to have the optical axis OB bent by the prism 12. The first lens group 1 is a lens group fixed to the main barrel 10.

The optical system is further provided with a second lens group 2, which is incorporated in a second lens group frame 2k. The second lens group moves integrally with the second lens group frame 2k at time of varying power (hereinafter, may be referred also to zooming).

The optical system is further provided with a third lens group 3, which is incorporated in the main barrel 10 and does not move.

The optical system is further provided with a fourth lens group 4, which is incorporated in a fourth lens group frame 4k. The fourth lens group is a lens group which moves unitedly with the fourth lens group frame 4k at time of varying power and adjusting focus (hereinafter, may be referred also to focusing).

The optical system is further provided with an optical filter 5 composed of an infrared ray cut filter and an optical low-pass filter which are layered. There is provided an image pickup element 6, for which a CCD (charge coupled device) image sensor or a CMOS (complementary metal-oxide semiconductor) image sensor is used.

The image pickup element 6 is fixed on drive member 60. The image pickup element 6 is moved by the drive member 60 in the directions P and Y in a plane perpendicular to the optical axis OB. The drive member 60 includes pitch direction position sensor 62P, yaw direction position sensor 62Y which detect movement positions respectively of pitch direction actuator 61P, yaw direction actuator 61Y and image pickup element 6 which are shown in FIG. 2.

Incidentally, the structure of the drive member 60 which moves image pickup element 6 in the plane may be one which is commonly known, and for example, an actuator employing a piezoelectric element that is described in JP-A No. 2003-110929 may be utilized.

As shown in FIG. 3, flexible print board FPC is connected to image pickup element 6 and drive member 60, and is connected to another circuit in a camera.

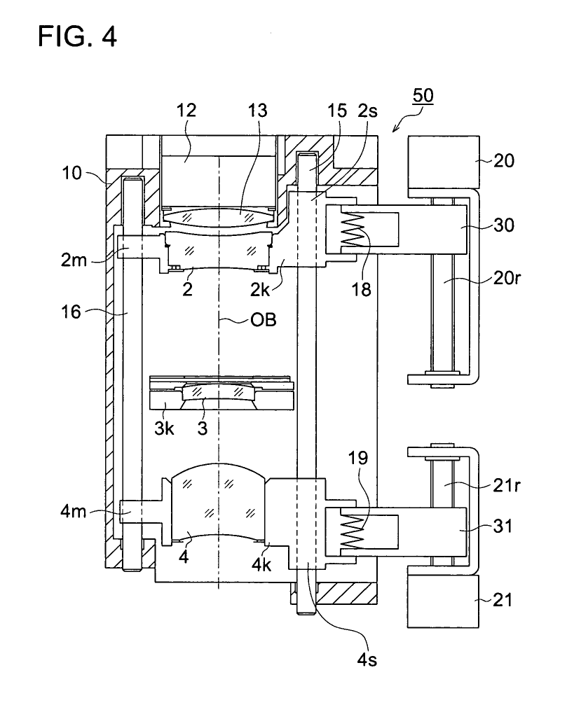

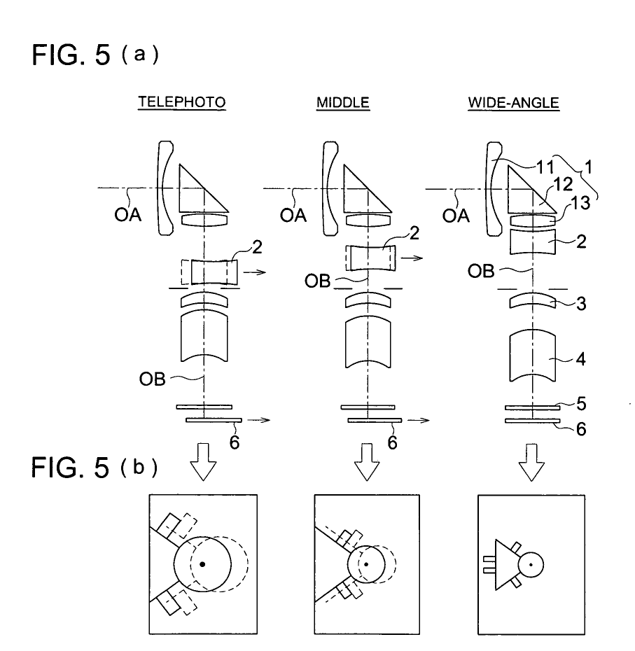

FIG. 4 is a schematic diagram showing an outline of a drive mechanism (a drive member) for varying power in lens barrel 50 relating to the First Embodiment. FIG. 4 shows that second lens group 2 and fourth lens group 4 are at wide-angle positions.

As shown in FIG. 4, guide shaft 15 is provided to pass through sleeve 2s formed solidly with second lens group lens frame 2k and sleeve 4s formed solidly with fourth lens group lens frame 4k. Further, guide shaft 16 is provided to engage with rotation engagement section 2m formed solidly with second lens group lens frame 2k and rotation engagement section 4m formed solidly with fourth lens group lens frame 4k. Due to this, the second lens group lens frame 2k and the fourth lens group lens frame 4k are made to be capable of sliding in the optical axis OB direction along the shafts 15 and 16.

Lead screw 20r representing a male screw member formed on a rotary shaft of first motor 20 that is a stepping motor is engaged with female screw member 30 (hereinafter referred to as a nut). This nut 30 is stopped in terms of rotation, which is not illustrated, and thereby, it is moved by the rotation of the first motor 20, namely, by the rotation of the leas screw 20r. Inside of the nut 30, there is arranged compression coiled spring 18 representing an urging member, and the nut 30 is engaged with sleeve section 2s at U-shaped portion formed on the sleeve section 2s. Owing to this, the second lens group 2 is moved along the guide shafts 15 and 16 by movement of the nut 30.

In the same way, female screw member 31 (hereinafter referred to as a nut) is engaged with lead screw 21r representing a male screw formed on a rotary shaft of the second motor 21 that is a stepping motor. This nut 31 is engaged with sleeve section 4s at U-shaped portion formed on the sleeve section 4s. Owing to this, the fourth lens group 4 is moved along guide shafts 15 and 16 by the movement of the nut 31.

In the structure of this kind, under the condition, for example, that the parallelism of the guide shafts 15 and 16 with optical axis OB is not correct, or that an optical axis of at least one of the second lens group 2 and the fourth lens group 4 is shifted, image moves during movement of the lens groups for varying power.

There will be given below an explanation of a specific example wherein image pickup element 6 is moved to prevent image from movement, in lens barrel 50 of camera 100 relating to the First Embodiment.

FIGS. 5(a) and 5(b) are schematic diagrams showing operations in the case of preventing image from movement when varying power. Examples shown in FIGS. 5(a) and 5(b) represent diagrams showing movement operations of image pickup element 6 when the second lens group 2 shifts during varying power.

The following description is given with considering a lens barrel as shown in FIG. 5(a). In the lens barrel, when the second lens group 2 and the fourth lens group 4 moves so that they approach the third lens group 3, from the wide-angle end, to be in the state of middle and to the telephoto end, the second lens group 2 is shifted from the optical axis OB in the arrow direction in FIG. 5(a).

In this lens barrel, when image pickup element 6 is fixed, an image of a subject on the optical axis OB at the wide-angle end is gradually deviated as the power is varied, as shown with broken lines in FIG. 5(b), and it moves on the image pickup plane. In this case, in the present embodiment, the image pickup element 6 is moved in the illustrated arrow direction in FIG. 5(a) to cancel the aforesaid deviation on the plane perpendicular to the optical axis OB by using the drive member, as shown in FIG. 5(a). Due to this, it is possible to provide an image pickup apparatus such that a subject image located at the center of the image pickup plane may not be moved even in the case of varying power, as shown with solid lines in FIG. 5(b).

Incidentally, though an explanation was given in FIGS. 5(a) and 5(b) with an example where the second lens group 2 is shifted on the plane including optical axes OB and OA, the invention is not limited to this. When any lens group moving for varying power, which includes the other lens than the second lens group, generates image movement due to shift and tilt caused by the movement of the lens group, the image can be prevented from the movement by moving an image pickup element with drive member 60 (see FIG. 3) so as to cancel the image movement.

With respect to an amount of movement and a direction of movement of the image pickup element 6, varying power operations are conducted for each lens barrel in the manufacturing process in advance, and an amount of shifting and a direction of shifting of a central image at prescribed focal lengths which are caused by varying power are measured. Thereby, the amount of movement and the direction of movement of the image pickup element 6 for canceling this measured shifting are determined. These amounts of movement (movement position) and the directions of movement thus determined are recorded, for example, on EEPROM 82 shown in FIG. 2. When varying the power, an amount of movement corresponding to each focal length is read out of the EEPROM 82, and the image pickup element 6 is moved. For example, in an image pickup apparatus wherein the power is varied by using a stepping motor, information about an amount of movement and a direction of movement is read out of EEPROM 82 at a timing corresponding to a pulse signal inputted to the stepping motor during varying power, and the image pickup element 6 is moved based on the information.

Further, in an image pickup apparatus wherein lens positions for varying power are determined in advance at plural prescribed points, or in an image pickup apparatus wherein stepping zoom is conducted, information about an amount of movement and a direction of movement is read from EEPROM 82 at each lens position during varying power, and the image pickup element 6 is moved based on the information.

Alternatively, information about an amount of movement and a direction of movement can be read out at the last moment of varying power operations, to move the image pickup element 6 based on the information.

Alternatively, information about an amount of movement and a direction of movement can be obtained by calculation, because the amount and the direction of deviation of the central image due to varying power are changed smoothly. At first, the amount and the direction of deviation are measured at several points including the wide-angle end, middle, and telephoto end, and the amount of movement and the direction of movement at each position in regions between the measured points can be obtained by interpolation.

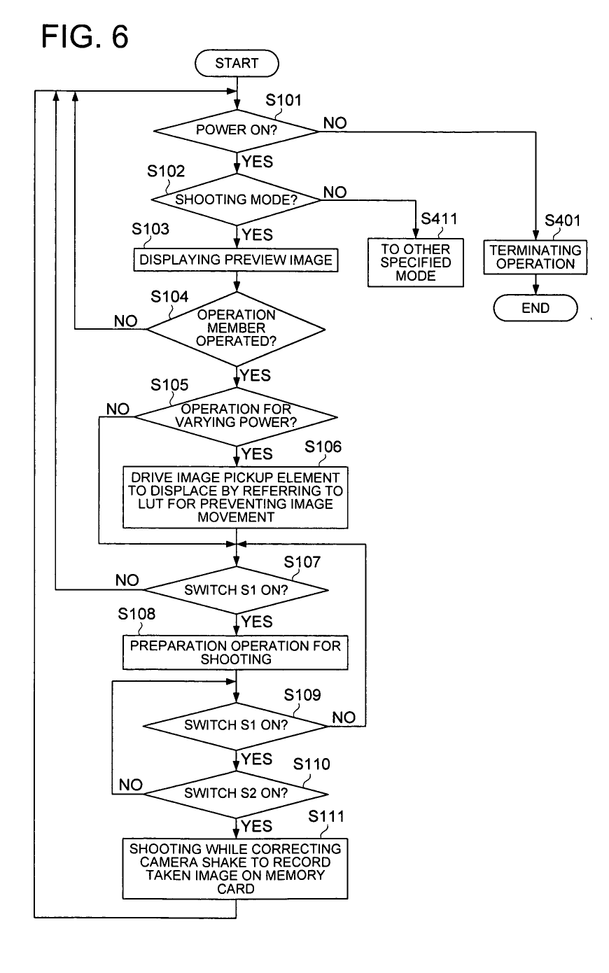

FIG. 6 is a flow chart showing an outline of operations of a shooting mode of camera 100 relating to the First Embodiment. An explanation will be given as follows, referring to the flow shown in FIG. 6.

In the flow shown in FIG. 6, the camera is judged first whether it is on the state of POWER-ON or not (step S101). When it is on the state of POWER-OFF (step S101; No), terminating operations of each section are conducted (step S401), to terminate.

When the camera is in the state of POWER-ON (step S101; Yes), the camera is judged next whether it is in the shooting mode or not (step S102). When the camera is not in the shooting mode (step S102; No), namely, when the mode is changed to another mode, the flow moves to the other specified mode (step S411). When the camera is in the shooting mode (step S102; Yes), an image for preview is displayed (step S103). Then, the flow is on standby for the operation member to be operated (step S104). When the operation member is not operated (step S104; No), the flow returns to step S101, and step S101 through step S104 are repeated.

When the operation member has been operated (step S104; Yes), the operation is judged whether it uses varying power operations or not (step S105). Namely, it is judged whether a zoom switch among a group of operation switches has been operated or not. When it has been operated to use varying power operations (step S105; Yes), the first motor 20 and the second motor 21 (see FIG. 2 and FIG. 4) are driven to move a lens group for varying power operations. In the course of this varying power operation, the image pickup element is driven to be displaced (moved), based on LUT of an amount of movement of an image pickup element (movement position) and a direction of movement of an image pickup element which are recorded on EEPROM 82 (see FIG. 2) in advance, thus, image movement is prevented (step S106). When the operation does not use the power varying operation (step S105; No), the step S106 jumps to conduct operation corresponding to the operation switch, and then, the flow is on standby for switch S1 to be turned on (step S107).

When the switch S1 is not turned on (step S107; No), operations of step S101 through step S106 are repeated.

When the switch S1 is turned on (step S107; Yes), preparation operations for shooting are conducted (step S108). The preparation operations for shooting include, for example, AF operations and determination of exposure conditions in the course of shooting.

At a point of time when the preparation operations for shooting are terminated, the switch S1 is confirmed again whether it is turned on or not (step S109). When the switch S1 is not turned on (step S109; No), the flow returns to step S107. When the switch S1 is turned on (step S109; Yes), switch S2 is made to be on standby to be turned on (step S110). When the switch S2 is not turned on (step S110; No), the flow returns to step S109.

When the switch S2 is turned on (step S110; Yes), the camera shoots an image with correcting camera shake that moves an image pickup element, and the image thus taken are recorded on a memory card (step S111), and the flow returns to step S101. In this way, the shooting for one frame is terminated.

As described above, First Embodiment employs a drive member that moves the image pickup element on a plane perpendicular to the optical axis of the image pickup optical system, and provides an image pickup apparatus in which the drive member moves the image pickup element on a plane perpendicular to the optical axis of the image pickup optical system when varying power of the image pickup optical system. By providing the image pickup apparatus, it is possible to prevent image from movement caused by a deviation (a shift or a tilt) from the optical axis generated when lens group moves for varying power resulted from minute part errors of lens barrel 50 or manufacturing errors of lens barrel 50.

### Second Embodiment

The Second Embodiment will be explained as follows. Since a camera representing an example of an image pickup apparatus relating to the Second Embodiment is the same as one shown in FIG. 1, an explanation for that will be omitted.

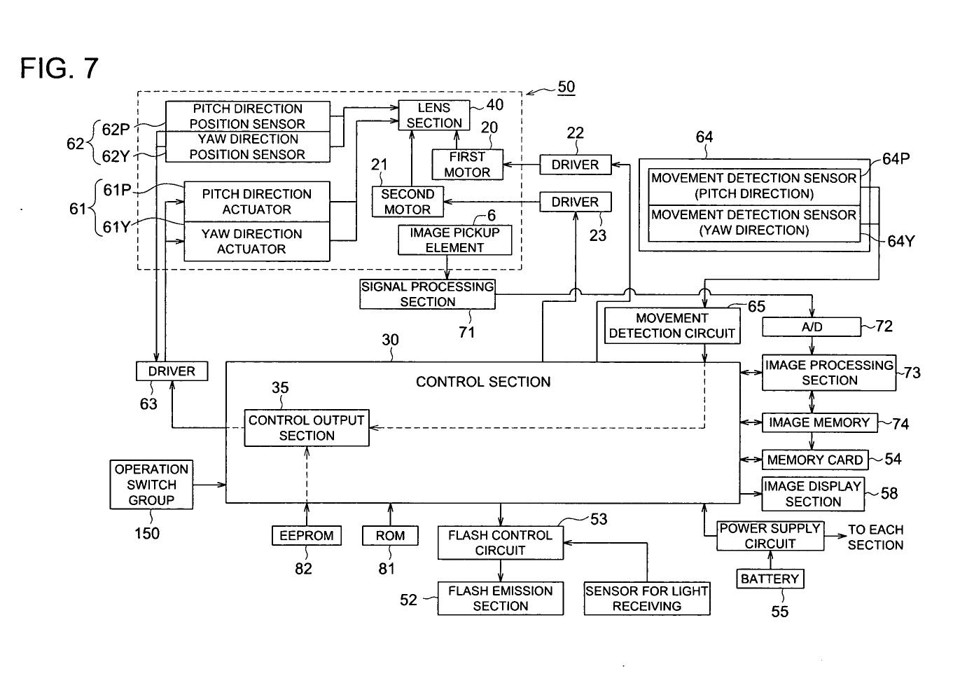

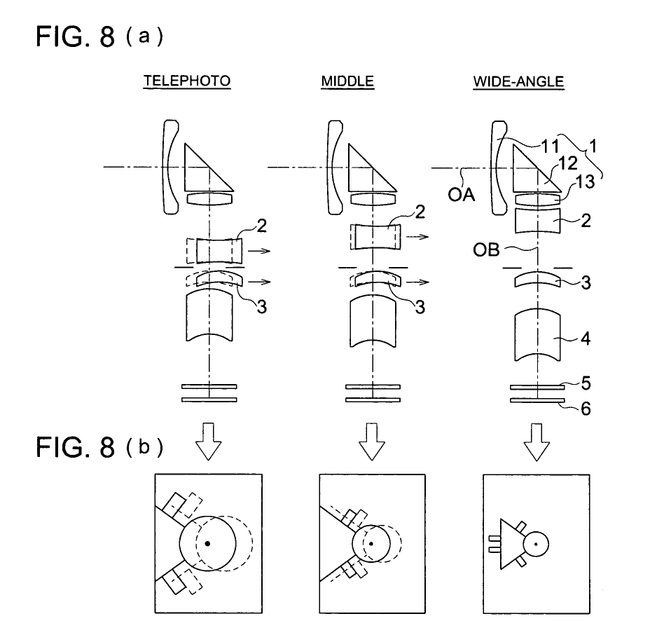

FIG. 7 is a block diagram showing a brief overview of camera 100 relating to the Second Embodiment. The block diagram shown in FIG. 7 is mostly common to the block diagram shown in FIG. 2, and different portions only will be explained accordingly.

In the block diagram shown in FIG. 7, there is provided actuator 61 that moves a prescribed lens group in the direction to cancel image movements in the yaw direction and the pitch direction shown in FIG. 1. A movement of a prescribed lens group in the pitch direction is conducted by pitch direction actuator 61P, and a movement of a prescribed lens group in the yaw direction is conducted by yaw direction actuator 61Y. Further, sensor 62 that detects a position of movement of a prescribed lens group moved by actuator 61 is provided, so that a position in the pitch direction is detected by pitch direction position sensor 62P and a position in the yaw direction is detected by yaw direction position sensor 62Y.

Namely, the Second Embodiment provides a drive member that moves at least a part of a lens group in an image pickup optical system in the direction that is different from an optical axis direction of the image pickup optical system.

Incidentally, the structure of the drive member that moves a lens group in the direction different from an optical axis direction may be a widely known structure, and for example, an electromagnetic actuator composed of a coil and a magnet described in JP-A No. 2000-13671 may be applied.

A specific example of an image pickup apparatus relating to the Second Embodiment will be explained, under the condition that a lens group moved for preventing image from movement in a lens barrel of the image pickup apparatus is the third lens group.

FIGS. 8(a) and 8(b) are schematic diagrams showing operations in the case of preventing image from movement when varying power. Examples shown in FIGS. 8(a) and 8(b) represent a diagram showing movement operations of the third lens group under the condition that the second lens group 2 is shifted when varying power.

The following description is given with considering a lens barrel as shown in FIG. 8(a). In the lens barrel, when the second lens group 2 and the fourth lens group 4 moves so that they approach the third lens group 3, from the wide-angle end, to be in the state of middle and to the telephoto end, the second lens group 2 is shifted from the optical axis OB in the arrow direction in FIG. 8(a).

In this lens barrel, when the third lens group 3 is fixed, an image of a subject on the optical axis OB at the wide-angle end is gradually deviated as the power is varied, as shown with broken lines in FIG. 8(b), and it moves away from the center of the image pickup plane. In this case, in the present embodiment, the third lens group 3 is moved in the illustrated arrow direction in FIG. 8(a) to cancel the aforesaid deviation on the plane perpendicular to the optical axis OB by using the drive member, as shown in FIG. 8(a). Due to this, it is possible to provide an image pickup apparatus such that a subject image located at the center of the image pickup plane may not be moved even in the case of varying power, as shown with solid lines in FIG. 8(b).

Incidentally, though an explanation was given in FIGS. 8(a) and 8(b) with an example where the second lens group 2 is shifted on the plane including optical axes OB and OA, the invention is not limited to this. When any lens group moving for varying power, which includes the other lens than the second lens group, generates image movement due to shift and tilt caused by the movement of the lens group, the image can be prevented from the movement by moving, for example, the third lens group 3 with drive member 60 so as to cancel the image movement.

With respect to an amount of movement and a direction of movement of the third lens group 3, varying power operations are conducted under the condition that the third lens group 3 is fixed for each lens barrel in the manufacturing process in advance, and an amount of shifting and a direction of shifting of a central image at a prescribed focal length which are caused by varying power are measured. Thereby, the amount of movement and the direction of movement of the third lens group for canceling this measured shifting are determined. These amounts of movement (movement position) and the directions of movement thus determined are recorded on EEPROM 82 shown, for example, in FIG. 2. When varying the power, an amount of movement corresponding to each focal length is read out of the EEPROM 82, and the third lens group 3 is moved. For example, in an image pickup apparatus wherein the power is varied by using a stepping motor, information about an amount of movement and a direction of movement is read out of EEPROM 82 at a timing corresponding to a pulse signal inputted to the stepping motor during varying power, and the third lens group 3 is moved based on the information.

Further, in an image pickup apparatus wherein lens positions for varying power are determined in advance at plural prescribed points, or in an image pickup apparatus wherein stepping zoom is conducted, information about an amount of movement and a direction of movement is read from EEPROM 82 at each lens position during varying power, and the third lens group 3 is moved based on the information.

Alternatively, information about an amount of movement and a direction of movement can be read out at the last moment of varying power operations, to move the third lens group 3 based on the information.

Alternatively, information about an amount of movement and a direction of movement can be obtained by calculation, because the amount and the direction of deviation of the central image due to varying power are changed smoothly. At first, the amount and the direction of deviation are measured at several points including the wide-angle end, middle, and telephoto end, and the amount of movement and the direction of movement at each position in regions between the measured points can be obtained by interpolation.

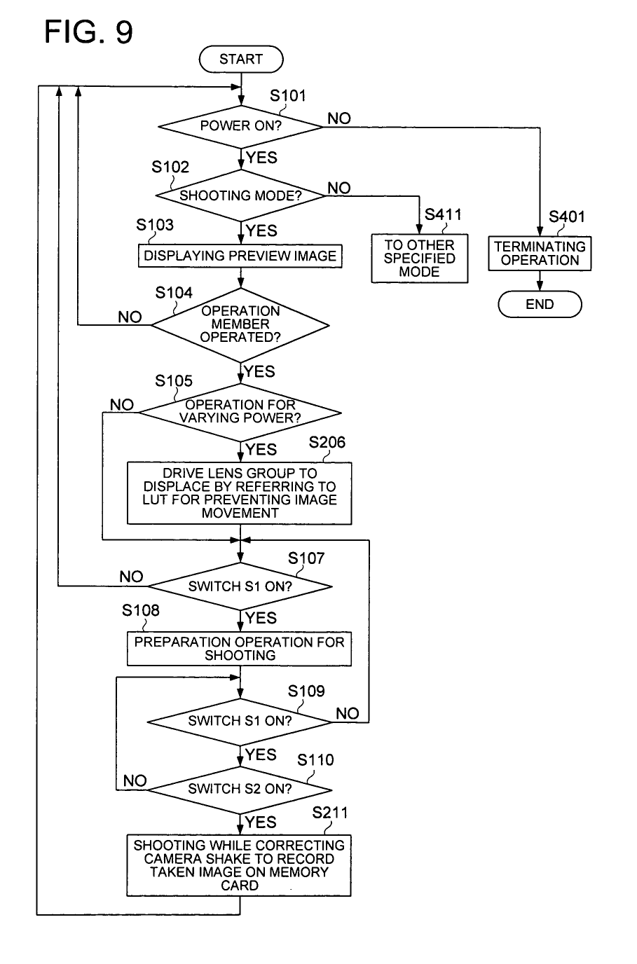

FIG. 9 is a flow chart showing an outline of operations in a shooting mode of a camera relating to the Second Embodiment. The flow chart shown in FIG. 9 is mostly common to the flow chart shown in FIG. 6, and therefore, the common portions are given the same symbols, and different portions only will be explained.

In the flow chart shown in FIG. 9, steps S101 through S104 are common to those in FIG. 6, and explanations for them will be omitted here accordingly.

In step S105, the camera is judged whether the operation is uses varying power operations or not. Namely, it is judged whether a zoom switch among a group of operation switches has been operated or not. When it has been operated to use varying power operations (step S105; Yes), the first motor 20 and the second motor 21 (see FIG. 2 and FIG. 4) are driven to move a lens group for varying power operations. In the course of this varying power operation, the third lens group 3 is driven to be displaced (moved), based on LUT of an amount of movement (movement position) and a direction of movement of the third lens group 3 which are recorded on EEPROM 82 (see FIG. 2) in advance, and image movement is prevented (step S206). When the operation does not use the power varying operation (step S105; No), the step 206 jumps to conduct operation corresponding to the operation switch, and then, the flow is on standby for switch S1 to be turned on (step S107).

When the switch S1 is not turned on (step S107; No), operations of step S101 through step S206 are repeated.

When the switch S1 is turned on (step S107; Yes), preparation operations for shooting are conducted (step S108). The preparation operations for shooting include, for example, AF operations and determination of exposure conditions in the course of shooting.

At a point of time when the preparation operations for shooting are terminated, the switch S1 is confirmed again whether it is turned on or not (step S109). When the switch S1 is not turned on (step S109; No), the flow returns to step S107. When the switch S1 is turned on (step S109; Yes), switch S2 is made to be on standby to be turned on (step S110). When the switch S2 is not turned on (step S110; No), the flow returns to step S109.

When the switch S2 is turned on (step S110; Yes), the camera shoots an image with correcting camera shake that moves the third lens group 3, and the image thus taken are recorded on a memory card (step S211), and the flow returns to step S101. In this way, the shooting for one frame is terminated.

As described above, Second Embodiment employs a drive member that moves at least a part of lens group in a direction different from an optical axis of the image pickup optical system, and provides an image pickup apparatus in which the drive member moves the lens group in a direction different from the optical axis of the image pickup optical system when varying power of the image pickup optical system. By providing the image pickup apparatus, it is possible to prevent image from movement caused by a deviation (a shift or a tilt) from the optical axis generated when lens group moves for varying power resulted from minute part errors of lens barrel 50 or manufacturing errors of lens barrel 50.

Incidentally, though the Second Embodiment employs the structure wherein the third lens group is moved, the invention is not limited to the foregoing. Any lens group to be moved in the direction different from the optical axis can be properly selected, corresponding to the variously designed image pickup optical systems.

Further, the present example can be applied also to an image pickup apparatus equipped with a lens barrel having the structure wherein an image pickup element is fixed and the whole image pickup optical system is moved to correcting image shake due to camera shake. In this case, varying power operations are conducted for each lens barrel in the manufacturing process in advance, and an amount of shifting and a direction of shifting of a central image at prescribed focal lengths which are caused by varying power are measured. Thereby, the amount of movement and the direction of movement of the entire of image pickup optical system for canceling this measured shifting are determined. These amounts of movement (movement position) and the directions of movement thus determined are recorded, for example, on EEPROM 82 shown in FIG. 2. When varying the power, an amount of movement corresponding to each focal length is read out of the EEPROM 82, and the entire of image pickup optical system moved. Thus, it can prevent the image from movement.

### Third Embodiment

The Third Embodiment will be explained as follows. Since an appearance of a camera representing an example of an image pickup apparatus relating to the Third Embodiment is the same as one shown in FIG. 1, an explanation for that will be omitted.

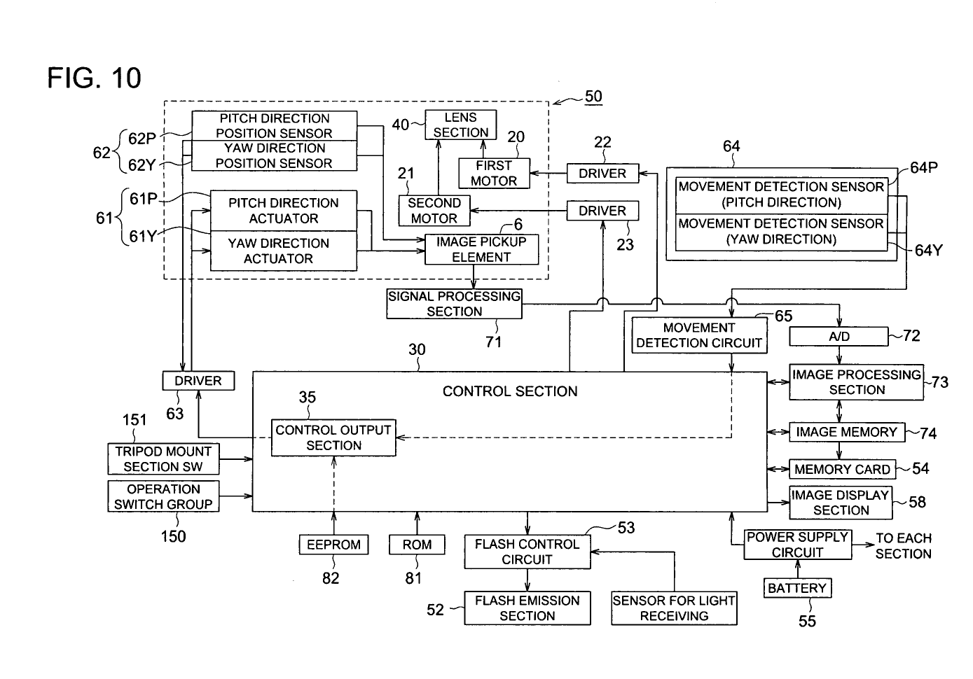

FIG. 10 is a block diagram showing a brief overview of camera 100 relating to the Third Embodiment. The block diagram shown in FIG. 10 is mostly common to the block diagram shown in FIG. 2, and different portions only will be explained accordingly.

In the block diagram shown in FIG. 10, there is constituted so that information of tripod mount section switch 151 that judges whether camera 100 is mounted on a tripod or not may be inputted in control section 30.

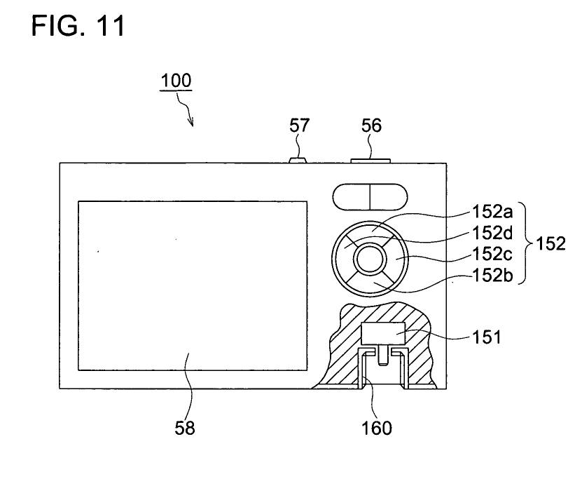

FIG. 11 is a sectional view showing an outline of switch 151 at a tripod mount section. FIG. 11 is a diagram that is acquired when camera 100 is viewed from its rear side.

As shown in FIG. 11, tripod mount section 160 on which a female screw is formed is arranged on a bottom surface of camera 100. Inside this tripod mount section 160, there is arranged tripod mount section switch 151 whose state is switched when a tripod mount representing a male screw is engaged with the tripod mount section 160 to push the tripod mount section switch 151. This tripod mount section switch 151 is arranged so that it can judge whether camera 100 is mounted on the tripod or not.

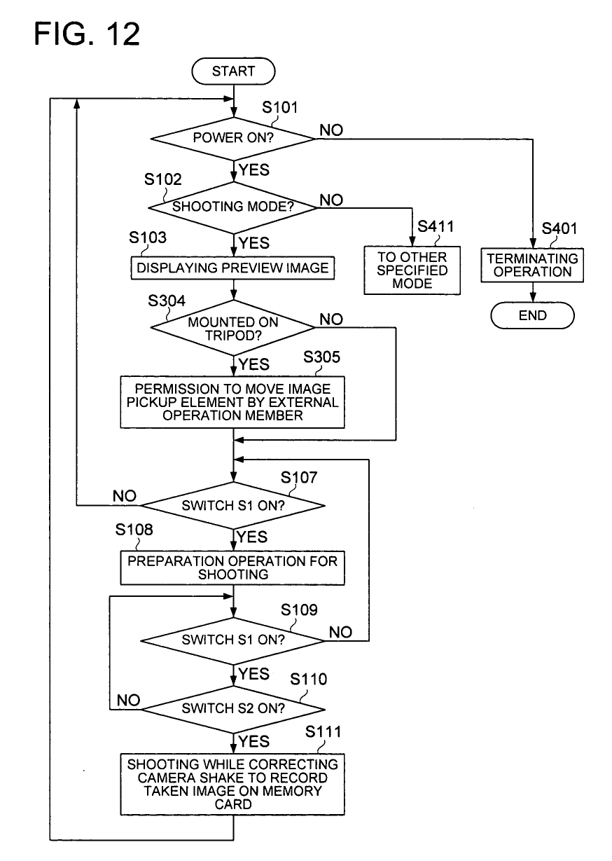

FIG. 12 is a flow chart showing an outline of operations in a shooting mode of a camera relating to the Third Embodiment. The flow chart shown in FIG. 12 is common partially to the flowchart shown in FIG. 6, and therefore, common parts are given the same symbols and an explanation for them will be omitted, and different portions only will be explained.

In the flow chart shown in FIG. 12, an explanation for steps S101 through S103 will be omitted, because they are common to those in FIG. 6.

After display of the image for preview is started in step S103, a camera is judged whether it is mounted on a tripod or not (step S304), which is judged by the condition of the tripod mount section switch 151 (see FIG. 11). Under the condition that the camera is judged to be mounted on the tripod (step S304; Yes), the control section 30 (see FIG. 10) controls to move an image pickup element when the external operation member is operated (step S305). Specifically, for example, when button 152a in cross-key button 152 shown in FIG. 11 is operated, an image pickup element is moved so that an image-shooting area may be moved upward, while, when button 152b is operated, an image pickup element is moved so that the image-shooting area may be moved downward. Further, when button 152c is operated, an image pickup element is moved so that the image-shooting area may be moved rightward, while, when button 152d is operated, an image pickup element is moved so that the image-shooting area may be moved leftward. By doing this, it is possible to conduct a fine adjustment of an image-shooting area, namely, a change of framing, corresponding to operations of a photographer without loosening a cramp that fixes a pan head of a tripod.

When a camera is judged not to be mounted on a tripod (step S304; No), step 305 jumps, and does not conduct the control to move an image pickup element even when an external operation member is operated.

Then, switch S1 is on standby to be turned on (step S107). When the switch S1 is not turned on (step S107; No), operations of step S101 through step S305 are repeated.

When the switch S1 is turned on (step S107; Yes), preparation operations for shooting are conducted (step S108). At a point of time when the preparation operations for shooting are terminated, the switch S1 is confirmed again whether it is turned on or not (step S109), and when the switch S1 in not turned on (step S109; No), the flow returns to step S107. When the switch S1 in turned on (step S109; Yes), switch S2 is on standby to be turned on (step S110). When the switch S2 is not turned on (step S110; No), the flow returns to step S109.

When the switch S2 is turned on (step S110; Yes), the camera shoots an image with correcting image shake due to camera shake that moves an image pickup element, and the image thus taken is recorded on a memory card (step S111), and the flow returns to step S101. In this way, the shooting for one frame is terminated.

As stated above, Third Embodiment employs a drive member that moves an image pickup element on the plane perpendicular to the optical axis of the image pickup optical system, and provides an image pickup apparatus in which an image-shooting area may be shifted by driving the drive member through operations of an external operation member. By providing the image pickup apparatus, it is possible to obtain a camera wherein fine adjustment of an image-shooting area can be conducted easily without loosening a cramp even when the camera is mounted on a tripod, and operability is improved.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

For example, Third Embodiment employs an image pickup apparatus in which the image pickup element is moved, it is naturally possible to constitute so that fine adjustment of the image-shooting area may be conducted by moving a prescribed lens group.

It is further possible to add features of the Third Embodiment to the image pickup apparatus of the aforesaid First Embodiment or the Second Embodiment. Namely, it is also possible to provide an image pickup apparatus including an ability to prevent image from movement when varying power by moving an image pickup element or a prescribed lens group, and an ability to conduct fine adjustment of framing when a tripod is fixed by moving an image pickup element or a prescribed lens group through operations of an external operation member.

Further, though each of the aforesaid First—Third Embodiments employs a lens barrel constructed to move a lens group by a lead screw and a nut, as an example, the invention is not limited to this. It is naturally possible to apply to the image pickup apparatus equipped with a lens barrel wherein a lens group is moved by a cam drum for varying power.

Though each of the aforesaid First—Third Embodiments employs a folded optical system having a reflecting surface bending the optical axis of the optical system, it may also employ an optical system without reflecting surface.

Further, it is also possible to employ an image pickup apparatus in which a movement detection sensor is omitted, camera shake correction is not conducted, and which includes at least one of an ability to prevent image from movement when varying power by moving an image pickup element or a prescribed lens group, and an ability to conduct fine adjustment of framing when a tripod is fixed by moving an image pickup element or a prescribed lens group through operations of an external operation member.

What is claimed is:

1. An image pickup apparatus comprising:
an image pickup optical system with variable power for forming an image of an subject;
an image pickup element for photo-electrically converting the image formed by the image pickup optical system; and
a drive member for moving the image pickup element in a plane perpendicular to an optical axis of the image pickup optical system,
wherein when power of the image pickup optical system is varied, the drive member moves the image pickup element in the plane perpendicular to the optical axis of the image pickup optical system, to correct a movement of the image due to varying the power.

2. The image pickup apparatus of claim 1,
wherein the drive member corrects an image shake due to a shake of the image pickup apparatus when the image pickup apparatus shoots the image.

3. The image pickup apparatus of claim 1, further comprising a recording medium storing information about an amount and direction of a movement of the image pickup element,
wherein when the power of the image pickup optical system is varied, the drive member moves the image pickup element in the plane perpendicular to the optical axis of the image pickup optical system based on the information stored in the recording medium.

4. An image pickup apparatus comprising:
an image pickup optical system with variable power for forming an image of an subject;
an image pickup element for photo-electrically converting the image formed by the image pickup optical system; and
a drive member for moving at least a part of the image pickup optical system in a direction different from an optical axis of the image pickup optical system,
wherein when power of the image pickup optical system is varied, the drive member moves the at least the part of the image pickup optical system in the direction different from the optical axis of the image pickup optical system, to correct a movement of the image due to varying the power.

5. The image pickup apparatus of claim 4,
wherein the drive member corrects an image shake due to a shake of the image pickup apparatus when the image pickup apparatus shoots the image.

6. The image pickup apparatus of claim 4, further comprising a recording medium storing information about an amount and direction of a movement of the at least the part of the image pickup optical system,
wherein when the power of the image pickup optical system is varied, the drive member moves the at least the part of the image pickup optical system in the direction different from the optical axis of the image pickup optical system based on the information stored in the recording medium.

7. An image pickup apparatus comprising:
an image pickup optical system with variable power for forming an image of an subject;
an image pickup element for photo-electrically converting the image formed by the image pickup optical system;
a drive member for moving the image pickup element in a plane perpendicular to an optical axis of the image pickup optical system; and
an external operation member for driving the drive member by an operation thereof to shift a shooting area of the image.

8. The image pickup apparatus of claim 7,
wherein the drive member corrects an image shake due to a shake of the image pickup apparatus when the image pickup apparatus shoots the image.

9. The image pickup apparatus of claim 7, further comprising:
a judging section for judging whether a tripod is attached to the image pickup apparatus or not,
wherein when the judging section judges that the tripod is not attached to the image pickup apparatus, the external operating member does not drive the drive member.

10. An image pickup apparatus comprising:
an image pickup optical system with variable power for forming an image of an subject;
an image pickup element for photo-electrically converting the image formed by the image pickup optical system;
a drive member for moving at least a part of the image pickup optical system in a direction different from an optical axis of the image pickup optical system, and
an external operation member for driving the drive member by an operation thereof to shift a shooting area of the image.

11. The image pickup apparatus of claim 10,
wherein the drive member corrects an image shake due to a shake of the image pickup apparatus when the image pickup apparatus shoots the image.

12. The image pickup apparatus of claim 10, further comprising:
a judging section for judging whether a tripod is attached to the image pickup apparatus or not,
wherein when the judging section judges that the tripod is not attached to the image pickup apparatus, the external operation member does not drive the drive member.
